(19) United States
(12) Patent Application Publication
(10) Pub. No.: US 2008/0063770 A1
(43) Pub. Date: Mar. 13, 2008

(54) Assembly and molding method adapted to mold food with complex profile

(76) Inventor: Chin-I Chang, Jhudong Township (TW)

Correspondence Address: BIRCH STEWART KOLASCH & BIRCH, PO BOX 747, FALLS CHURCH, VA, 22040-0747, US

(21) Appl. No.: 11/819,981

(22) Filed: Jun. 29, 2007

(30) Foreign Application Priority Data
Sep. 13, 2006 (TW) 095133786

(51) Int. Cl. A23P 1/10; A47J 43/18; A47J 43/20; F26B 5/06

(52) U.S. Cl. 426/515; 249/118; 426/444; 426/512; 99/426

(57) ABSTRACT

The invention provides a mold assembly. The mold assembly according to the invention includes two set of complementary split molds. In particularly, the mold assembly according to the invention enables the molding of food that has a shape with a complex profile.

### FIELD OF THE INVENTION

The present invention relates to a mold assembly. Particularly, the present invention uses a mold assembly which includes two sets of complementary split molds to mold food that has a shape with a complex profile.

### BACKGROUND OF THE INVENTION

Presently, there are many dealers in the food industry that adopt chocolate as a material to make various kinds of shapes of chocolate food products. In general, the way of making the chocolate food products is to fill up the cavity of a mold with chocolate. After a shape is formed, the chocolate food product with solid interior is finished. Moreover, there are also other dealers in the food industry that make the chocolate food products with hollow interior to economize the ingredient of chocolate to lower cost.

However, nowadays the molds for shaping food products are unable to provide the capability of making food with shapes which have higher complexity or multi-layer shape. Furthermore, ingredients for shaping foods are not limited to chocolate but can also be any other shapeable foods. It needs to be noted that the food products are immediately eatable after raw materials (ingredients) are coped with particular methods and procedures, such as chocolate or candy in a curing procedure, dessert in freezing procedure, cake in baking procedure, rice cake or dumplings in steaming procedure, . . . and etc.

Accordingly, a scope of the present invention provides a mold assembly and the molding method thereof. Under the structure of the mold assembly, food products having shapes with complex profiles can be molded.

### SUMMARY OF THE INVENTION

According to a preferred embodiment of the present invention, a method is provided for molding a food product that has a shape with a complex profile divided into N portions, and N is an integer larger than or equal to 2. The method according to the present invention first provides N complementary split inner molds of which each corresponds to one of the N portions and has a respective inner surface matching the corresponding portion. Subsequently, the method according to the present invention juxtaposes the N split inner molds to circumscribe an enclosed cavity matching the shape. The method according to the present invention provides and juxtaposes at least two complementary split external molds, which are capable of supporting the N complementary split inner molds to fit together tightly. The method according to the present invention fills a raw material (ingredient) of the food into the enclosed cavity. Then, the method according to the present invention solidifies the ingredient filled in the enclosed cavity. The method according to the present invention then removes the at least two split external molds from the N split inner molds. Finally, the method according to the present invention separates each of the N split inner molds from the solidified raw material to obtain the solidified food product that has the shape of a complex profile.

A mold assembly, according to a preferred embodiment of the present invention, is adapted to mold a food product that has a shape with a complex profile; the complex profile is divided into N portions, and N is an integer larger than or equal to 2. Each of the N complementary split inner molds corresponds to one of the N portions and has a respective inner surface matching the corresponding portion, juxtaposing to circumscribe an enclosed cavity matching the shape. At least two complementary split external molds are capable of supporting the N complementary split inner molds to fit tightly. Raw material of the food product is filled into the enclosed cavity and then is solidified. The at least two split external molds are removed from the N split inner molds. Each of the N split inner molds is then separated from the solidified raw material to obtain the solidified food product that has the shape of the complex profile.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 is a schematic diagram illustrating a structure of a mold assembly according to a preferred embodiment of the invention.

FIG. 2 is a combination diagram illustrating the assembled mold assembly according to a preferred embodiment of the invention.

FIG. 3 is a finished food product according to a preferred embodiment of the invention.

### DETAILED DESCRIPTION OF THE INVENTION

The present invention provides a mold assembly and the molding method thereof. Particularly, under the structure of the mold assembly, a food product that has a shape with a complex profile can be molded. The preferred embodiments according to the present invention will be described in detail in the following.

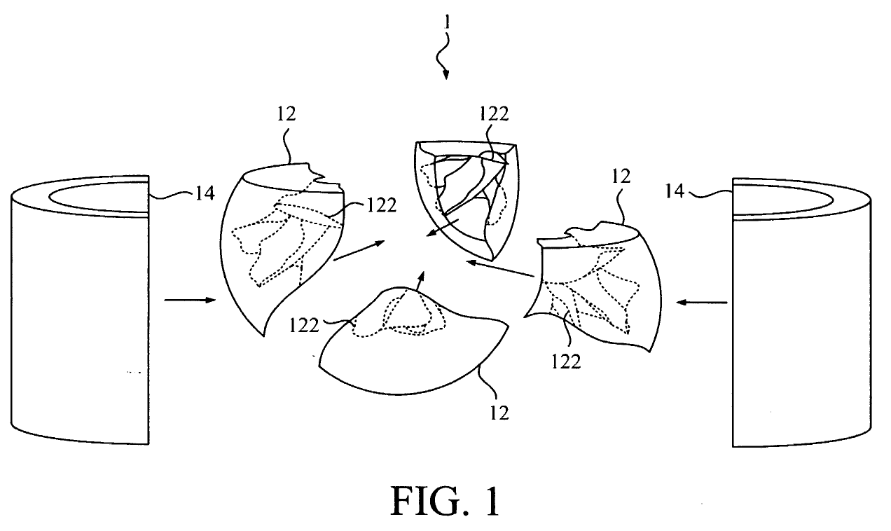

Referring to FIG. 1, FIG. 1 is a schematic diagram illustrating a structure of a mold assembly 1 according to a preferred embodiment of the invention. As shown in FIG. 1, the mold assembly 1 adapted to mold a food product having a shape with a complex profile is divided into N portions, and N is an integer larger than or equal to 2. In the embodiment, the complex profile is divided into four portions, but the number of divided portions is not limited by four.

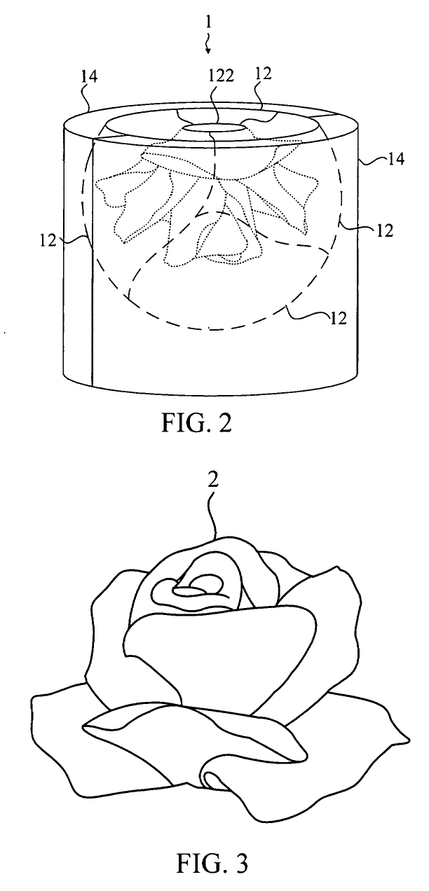

Referring to FIG. 2, FIG. 2 is a combination diagram illustrating the assembled mold assembly 1 according to a preferred embodiment of the invention. As shown in FIG. 2, each of the four complementary split inner molds 12 corresponds to one of the four portions and has a respective inner surface matching the corresponding portion, juxtaposing to circumscribe an enclosed cavity 122 matching the shape.

The same as shown in FIG. 2, the at least two complementary split external molds 14 are capable of supporting the four complementary split inner molds 12 to fit tightly together.

Referring to FIG. 3, FIG. 3 is a finished food product 2 according to a preferred embodiment of the invention. As shown in FIG. 3, raw material of the food 2 is filled into the enclosed cavity 122 and then is solidified. The at least two split external molds 14 are removed from the four split inner molds 12. Each of the four split inner molds 12 is separated from the solidified raw material to obtain the solidified food 2 that has the shape of a complex profile.

In another embodiment, the raw material is in a liquid state, a gel state, a glue state, or a mud state.

In another embodiment, the four complementary split inner molds 12 are formed of an edible silicone or stainless steel.

In another embodiment, the solidification of the raw material of the food is performed by a curing procedure, a freezing procedure, a baking procedure, or a steaming procedure.

According to the method of molding a kind of food 2 of a preferred embodiment of the present invention, food 2 has a shape with a complex profile. In the embodiment, the complex profile is divided into four portions, but the number of divided portions is not limited by four.

As shown in FIG. 1, the method according to the present invention first provides four complementary split inner molds 12 of which each corresponds to one of the four portions and has a respective inner surface matching the corresponding portion.

Subsequently, the method according to the present invention juxtaposes the four split inner molds 12 to circumscribe an enclosed cavity 122 matching the shape.

Furthermore, the method according to the present invention provides and juxtaposes at least two complementary split external molds 14 capable of supporting the four complementary split inner molds 12 to fit tightly together.

As shown in FIG. 2, the method according to the present invention fills a raw material of food 2 into the enclosed cavity 122.

Then, the method according to the present invention solidifies the raw material which is filled in the enclosed cavity 122.

The method according to the present invention removes the at least two split external molds 14 from the four split inner molds 12.

Finally, the method according to the present invention separates each of the four split inner molds 12 from the solidified raw material to obtain the solidified food 2 that has the shape of a complex profile.

In another embodiment, the raw material is in a liquid state, a gel state, a glue state, or a mud state.

In another embodiment, the four complementary split inner molds 12 are formed of an edible silicone or stainless steel.

In another embodiment, the solidification of the raw material of food 2 is performed by a curing procedure, a freezing procedure, a baking procedure, or a steaming procedure.

By the preferred embodiment of the present invention described above, obviously, the mold assembly and molding method thereof according to the present invention use a mold assembly which includes two set of complementary split molds to mold food that has a shape with a complex profile, without encountering the difficulties and limitations of the prior art when making food that has a shape with a complex profile.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method of molding a food having a shape with a complex profile divided into N portions, N being an integer larger than or equal to 2, said method comprising the steps of:
providing N complementary split inner molds which each corresponds to one of the N portions and has a respective inner surface matching the corresponding portion;
juxtaposing the N split inner molds to circumscribe an enclosed cavity matching the shape;
providing and juxtaposing at least two complementary split external molds capable of supporting the N complementary split inner molds to fit tightly together;
filling the raw material of the food into the enclosed cavity;
solidifying the raw material filled in the enclosed cavity;
removing the at least two split external molds from the N split inner molds; and
separating each of the N split inner molds from the solidified raw material to obtain the solidified raw material as being food having the shape with the complex profile.

2. The method of claim 1, wherein the raw material is in a liquid state, a gel state, a glue state, or a mud state.

3. The method of claim 1, wherein the N complementary split inner molds are formed of an edible silicone or stainless steel.

4. The method of claim 1, wherein the solidification of the raw material of the food is performed by a curing procedure, a freezing procedure, a baking procedure, or a steaming procedure.

5. A mold assembly adapted to mold a food having a shape with a complex profile divided into N portions, N being an integer larger than or equal to 2, said mold assembly comprising:
N complementary split inner molds, which each corresponds to one of the N portions and has a respective inner surface matching the corresponding portion, juxtaposing to circumscribe an enclosed cavity matching the shape; and
at least two complementary split external molds capable of supporting the N complementary split inner molds to fit tightly together;
wherein the raw material of the food is filled into the enclosed cavity, and then is solidified, the at least two split external molds are removed from the N split inner molds, each of the N split inner molds is separated from the solidified raw material to obtain the solidified raw material as being food having the shape with the complex profile.

6. The mold assembly claim 5, wherein the raw material is in a liquid state, a gel state, a glue state, or a mud state.

7. The mold assembly of claim 5, wherein the N complementary split inner molds are formed of an edible silicone or stainless steel.

8. The mold assembly of claim 5, wherein the solidification of the raw material of the food is performed by a curing procedure, a freezing procedure, a baking procedure, or a steaming procedure.
